(19) United States
(12) Patent Application Publication
(10) Pub. No.: US 2025/0038271 A1
(43) Pub. Date: Jan. 30, 2025

(54) METHOD OF MAKING FLEXIBLE LI-ION BATTERIES

(71) Applicant: Tuqiang Chen, Albuquerque, NM (US)

(72) Inventor: Tuqiang Chen, Albuquerque, NM (US)

(21) Appl. No.: 18/227,974

(22) Filed: Jul. 30, 2023

(51) Int. Cl. H01M 10/058; H01M 4/58; H01M 4/66; H01M 4/74; H01M 10/0525; H01M 10/0565; H01M 50/136

(52) U.S. Cl. CPC H01M 10/058; H01M 4/5825; H01M 4/661; H01M 4/74; H01M 10/0525; H01M 10/0565; H01M 50/136; H01M 2004/021

(57) ABSTRACT

The invention discloses a method of making flexible Li-ion batteries by forming a flexible patterned electrode preparation substrate, forming a flexible electrode on the patterned electrode preparation substrate, and forming a flexible Li-ion battery by self-bonding the flexible positive and negative electrodes. The method promotes the facile fabrication of flexible Li-ion batteries, and the patterned flexible electrode preparation substrate imparts structural flexibility to the devices. The method may also be adapted to make structural and self-healing Li-ion batteries.

### STATEMENT REGARDING FEDERALLY SPONSORED R&D

None.

### FIELD OF INVENTION

The invention relates to the field of Li-ion battery technologies involving battery structures and fabrications. More specifically, the invention relates to the field of flexible Li-ion technologies for flexible electronic applications.

### BACKGROUND OF THE INVENTION

The advancement of flexible devices, including wearable and implantable electronics, has stimulated intensive efforts to search for corresponding energy storage devices that match their flexibility and bendability. Li-ion batteries are of great interest for developing flexible energy storage devices due to their high energy densities, layered cell structures, and possibly the minimal amount of liquid involved.

A plausible approach to flexible energy storage devices is to develop flexible electrodes followed by integrating the electrodes into flexible devices. In this regard, tremendous efforts have been made in this area, including developing flexible electrodes and polymer electrolytes for Li-ion batteries or supercapacitors. The general approach to the development of flexible electrodes is having appropriate nanostructured active electrode materials embedded in or composited with a flexible substrate that may or may not be electrochemically active. For example, carbon nanotubes (CNTs), graphenes, carbon fibers, and carbon cloths have been used as flexible substrates for making flexible Li-ion anodes and cathodes. These flexible electrodes do improve device flexibility; however, they have significant limitations. The flexible electrodes are typically stacked and folded to form a device, which lacks sufficient adhesion between electrode layers to hinder delamination when devices are subject to repeated bending or folding. Other approaches to the fabrication of flexible Li-ion batteries or supercapacitors, including lamination, vacuum infiltration, coating, winding, or printing, have been investigated to form flexible energy storage devices of various configurations; however, none of them seem to be viable for large scale mass production.

In recent years, efforts have been made to improve the performances of Li-ion batteries and supercapacitors involving using metal mesh instead of metal foil as current collectors. Shi, et al. reported in a research article (Nano Energy, 2014, 6, 82-91) a flexible supercapacitor, prepared by deposition of carbon materials on stainless steel (SS) mesh, followed by assembly of a pair of mesh electrodes sandwiching a separator that is wetted with an organic liquid electrolyte. Unfortunately, due to insufficient adhesion between electrodes and separator, repeated bending may lead to failure of the supercapacitor due to layer separation. Chen disclosed a 3-D Li battery and a supercapacitor in a US patent (U.S. Pat. No. 9,905,370 B2), where ultrafine metal mesh (UMM) was used as a current collector. Thin films of electrode materials and solid-state electrolytes were sequentially deposited onto the surfaces of the ultrafine metal mesh wires, forming UMM-based electrodes. The UMM-based anodes and cathodes were alternately stacked and laminated using the electrolyte as adhesive, forming mesh-based 3-D energy storage devices for better electrochemical and mechanical performance characteristics. The metal mesh substrates and the laminated coating structures of the electrode materials and polymer electrolytes, forming a micro-composite structure, impart certain degrees of flexibility to the 3-D Li-ion batteries and supercapacitors; however, they are insufficient for substantial folding or bending.

These mesh-based electrodes, compared with conventional foil-based electrodes, allow the loading of more electrode materials for improved performance characteristics due to the higher porosity of mesh. These include higher energy and power densities. Additionally, a mesh substrate, for its pore structures and high surface area, promotes better bonding between electrode materials and the substrate. The novel structures of mesh-based energy storage devices disclosed in the US patent (U.S. Pat. No. 9,905,370 B2) also allow significant improvement over device flexibility because the energy storage device is a metal wire-reinforced composite having a continuous polymer electrolyte matrix. This improves flexibility and reduces the risk of delamination upon bending or folding. However, it must be realized that polymer electrolytes are not intended for structural applications; they may not have the mechanical strength to withstand repeated bending or folding of a flexible device. Therefore, additional features of flexibility were introduced to significantly improve the flexibility and bendability of the devices, as disclosed in the US patent (U.S. Pat. No. 11,038,179 B1). Owing to the open structure of the metal mesh, a flexible polymer packaging material was introduced as a patterned, well-distributed matrix phase of the mesh-based energy storage device, which significantly improved device flexibility and bendability.

The flexible energy storage devices disclosed in the US patent (U.S. Pat. No. 11,038,179 B1) have at least one patterned mesh-based anode and one patterned mesh-based cathode that are well-aligned and bonded by infiltrating flexible polymer packaging material into the patterned pore structures. The patterned, well-distributed, single-phase polymer matrix imparts significant flexibility to the device; however, it is highly challenging to make such flexible energy storage devices with such patterned composite structures, and the invention did not disclose any methods to make such devices. Therefore, a novel, cost-efficient method for making such flexible Li-ion batteries is disclosed in the present invention.

### SUMMARY OF THE INVENTION

These and other objectives are achieved in the present invention by 1) forming a Patterned Electrode Preparation Substrate (PEPS, 100) of polymer-metal mesh composite, using a pair of well-aligned Patterned Double-Sided Adhesive (PDSA) films, having an array of pore structures, sandwiching and pressing against a metal mesh current collector, followed by adhering a side of the PDSA film to a release liner to close an end of the array of pore structures; 2) forming a Patterned Composite Electrode (PCE, 200) by depositing electrode and electrolyte materials into the patterned pore structures of the PEPS on the release liner (30), 3) forming a flexible Li-ion battery by aligning, and seamless bonding a positive a negative PCEs using the double-sided adhesive on the PEPS, followed by packaging. It is noted that there are two release liners on both sides of the PDSA films, and the liners are peeled off only when bonding is needed. It is further noted that the Double-Sided Adhesive (DSA) may be pressure-sensitive, making the processes straightforward.

Accordingly, it is an object of the present invention to claim a novel, cost-efficient method of making flexible Li-ion batteries. The Patterned Electrode Preparation Substrate (PEPS) of polymer-metal mesh composite comprises arrays of pores of circular, rectangular, square, or polygonal. It is challenging to coat electrode and electrolyte materials on a porous metal mesh current collector, not to mention to do so with a complex pattern. However, these pore structures on the PEPSs, acting as a template, can readily host formations of arrays of Li-ion electrodes and, subsequently, form arrays of Li-ion cells that are connected in parallel using the metal mesh current collectors, making it possible for the facile fabrication of flexible Li-ion batteries comprising arrays of small Li-ion cells.

It is another object of the present invention to disclose a flexible Li-ion battery comprising an array of Li-ion cells, a flexible polymer matrix, and a pair of metal mesh current collectors, wherein the cells are embedded in the polymer matrix, and wherein the metal mesh current collectors are also embedded in the polymer matrix and the positive or negative electrodes. It is important to note that all the sheets of the PDSAs are bonded seamlessly to themselves, and some of them are bonded through the pores of the mesh current collectors, forming a continuous polymer phase throughout the structure of the Li-ion battery. This continuous phase of the flexible polymer matrix, the reinforcement of metal mesh current collectors, and the array of small Li-ion cells offer great structural flexibility to the Li-ion battery. More importantly, when the cells of the Li-ion battery array are sufficiently small or comparable with the bending or flexing radius, there will be no significant mechanical impact on these Li-ion cells when flexing or bending.

### BRIEF DESCRIPTION OF THE DRAWINGS

The principle of the present invention may be understood with reference to the detailed description, in conjunction with the accompanying drawings, in which:

FIG. 1 shows a process of forming a Patterned Electrode Preparation Substrate (PEPS, 100), wherein PEPS 100 is illustrated in a cross-sectional view, using a pair of well-aligned Patterned Double-Sided Adhesive (PDSA) films, having an array of pore structures, sandwiching and pressing against a metal mesh current collector, followed by adhering a side of the PDSA film to a release liner 30 to close an end of the pore structures for facile deposition of electrode and electrolyte materials.

FIG. 2 shows a process of forming a Patterned Composite Electrode (PCE, 200), wherein PCE 200 is illustrated in a cross-sectional view by depositing electrode (40) and electrolyte (50) materials into the patterned pore structures on the PEPS (100).

FIG. 3 shows a process of forming a flexible Li-ion battery (300) by aligning and self-bonding positive and negative PCEs using the PDSAs, wherein flexible Li-ion battery 300 is illustrated in a cross-sectional view. The flexible Li-ion battery is further packaged using a flexible metalized plastic pouch, which is not shown in the figure.

### DETAILED DESCRIPTION OF THE INVENTION

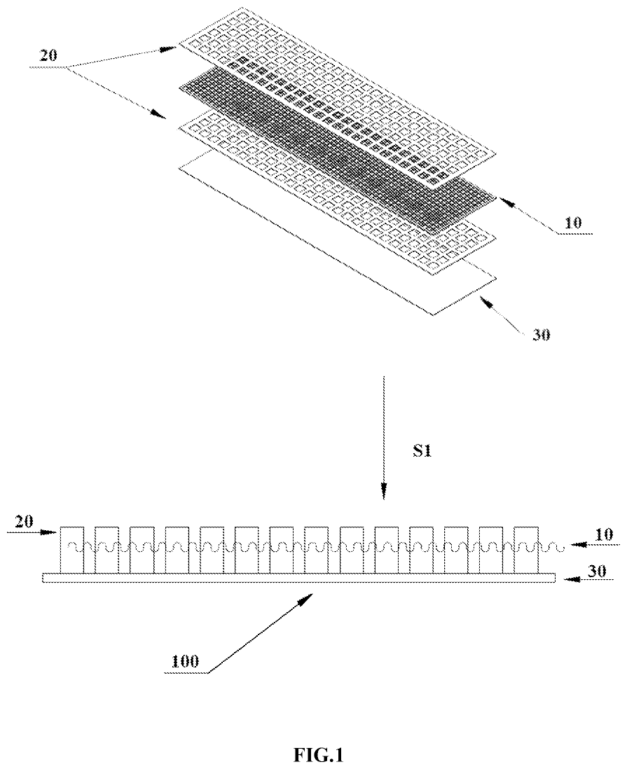

Referring now to FIG. 1 of the drawing is a process of making PEPS (100) by stacking, aligning, and self-bonding a pair of Patterned Double-Sided Adhesive (PDSA, 20) films that sandwich a sheet of metal mesh (10) and adhering to a release liner (30), using the DSA as adhesives. The pore structures of PEPS allow facile deposition of the Li-ion electrode and electrolyte, forming a flexible Li-ion electrode in the next step.

Metal mesh 10 is used as a current collector for conducting current. It is also used as a structural substrate for the deposition of electrode and electrolyte materials and for structural flexibility as well. The porous structure of metal mesh allows the pair of PDSA films to bond to themselves, having the mesh embedded in the self-bonded, integrated PDSA. Any suitable metals may be used for metal mesh 10, with Al, Cu, Ni, Sb, Cr, Fe, Pt, Si, or stainless steel (SS) as an example. A SS mesh with a thin layer of Al or Cu may also be used for the positive or negative current collector, respectively. It is noted that, in comparison with metal foil substrates of equivalent dimensions (thickness and area), metal mesh shows a much higher specific surface area due to its high porosity, which promotes the loading of more electrode materials for higher energy density and power density. While it is understood that smaller wire diameter and larger pore/opening size of mesh are favored for loading of more active materials, thus, better electrochemical performance, however, the structural and mechanical performance of the claimed device may be sacrificed substantially. Therefore, the mesh wire diameter and pore/opening size may have to be varied, for example, from 5 to 100 microns and pore/opening size from 5-300 microns, for a balanced overall performance for a specific application.

Double-Side Adhesives (DSAs) are used in a wide variety of applications in many industries. They often play an essential role in securing workpieces with regular or complex geometries to ensure efficient and safe seals and bonding in electronics and automobiles. A double-sided adhesive film/tape (DSA) usually features with same or different pressure-sensitive adhesives coated on both sides of a plastic carrier film, such as PET, and protected with a pair of release liners. For some applications, a DSA film is free of the plastic carrier. Processing plastic films, including DSA films, into patterned structures has been widely practiced for years. The processing techniques may include die-cutting and laser-cutting.

One of the most recent applications of DSAs is Optical Clear Adhesive (OCA), which has been widely used in many electronic and optical devices, including foldable cell phones. Many organic or inorganic adhesives can be used in DSAs, including silicone, acrylic, unsaturated polyester, polyurethane, and epoxy resin. In the present invention for flexible battery applications, silicone or acrylic adhesives may be preferred due to the flexibility and chemical and thermal resistance of these polymers. However, a curable adhesive resin such as epoxy is also of interest, as a structural battery may be formed when the resin is cured, resulting in a battery of a metal fiber (mesh) reinforced polymer composite with significantly improved structural strength. In addition, a self-healing polymer resin may also be used to self-heal from mechanically and thermally induced damage, therefore improving the battery's safety.

The electrodes of the device are formed in the pore structures of the PEPS. Therefore, the features of the PEPS pore structures, including pore geometry, size (diameter and depth), and pore density, will have a significant impact on the performance of the flexible Li-ion batteries, including the mechanical and electrochemical properties. The pore density is defined herein as the ratio of the area of total pores to the total area of the original DSA. It is obvious that improved flexibility for the device will be achieved with a small pore size and low pore density of the PEPS. However, such characteristics of the PEPS will lead to lower electrochemical performance, including energy and power density, due to the lowered loading of active electrode materials. Therefore, these characteristics of PEPS, including pore geometry, size, depth, and pore density, may have to be varied for a balanced overall performance for a specific application. As a result, the pore depth or DSA thickness may have to range from 25 to 200 microns, the pore size from 25 microns to 25 centimeters, and the pore density from 50% to 95%.

It is challenging to deposit electrode slurries and polymer electrolyte solutions or slurries on open pore structures. Therefore, release liner 30, attached to the bottom of the PEPS, is used to close one end of the pores, allowing facile deposition of electrode and electrolyte materials in the pore structures of the PEPS. While there are a wide variety of release liners available for the application, BO-PET film (biaxially oriented PET) coated with a silicone release agent on one side is preferred for its outstanding mechanical strength, dimensional stability, transparency, and high-temperature and chemical resistance.

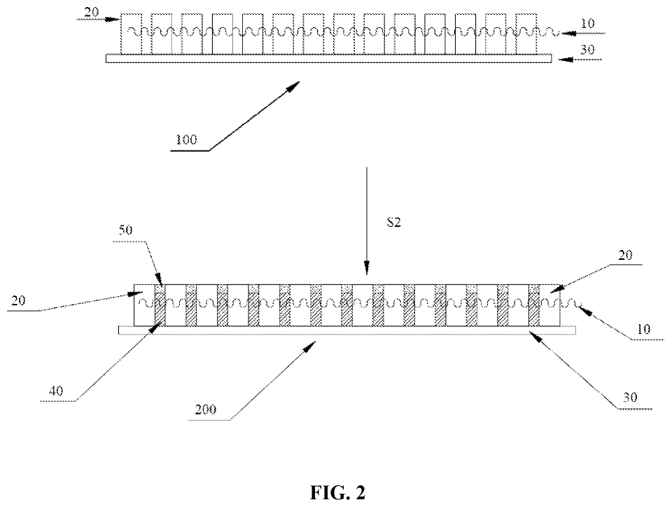

Referring to FIG. 2 of the drawing is a process of forming a Patterned Composite Electrode (PCE, 200) by depositing electrode (40) and electrolyte (50) materials into the patterned pore structures on PEPS 100, wherein PCE 200 is illustrated in a cross-sectional view. There may be a few ways for the deposition of electrode and electrolyte materials. However, the most appropriate approach may be the wet coating process of electrode slurries and polymer solutions/slurries followed by drying in an inert atmosphere at an elevated temperature. Other coating techniques, such as chemical vapor deposition (CVD) and physical vapor deposition (PVD), may be technically viable but need significantly higher processing temperatures and may be much more costly.

Li-ion batteries, as energy storage devices, commonly use a metal oxide as the cathode and a carbon material as the anode. Any suitable Li-ion battery cathode materials may be used to be deposited into the pores of the PEPS, with LiCoO₂, LiNiO₂, LiMn₂O₄, LiFePO₄, LiNiₓCo_{y}Mn_{z}, or LiNiₓCo_{y}Al_{z} as an example. These materials in powder form may be mixed with a conductive additive, a polymer binder, and a solvent to form a slurry, which may be applied to the pore structure of PEPS with the mesh wires being embedded. The relative proportions of active material, conductive additives, and polymer binder may range, for example, from 50 wt. % to 90 wt. % for the active material and 0 wt. % to 50 wt. % for the conductive additives, the balance being the polymer binder. The cathode materials may not cover the pores fully as polymer or gel polymer electrolytes need to be filled subsequently. As previously stated, the depth of the pores or the thickness of the DSA ranges from 25 microns to 200 microns, and the thickness of the cathode may not exceed 400 μm, noting that two layers of PDSAs are used to form PEPS.

Any suitable Li-ion anode material may be used in the invention, with Li metal, graphite, Si, or LiTiO (lithium titanate oxide) as an example. These materials, except Li metal, in powder form may be mixed with a conductive additive, a polymer binder, and a solvent to form a slurry, which may be applied to the pore structures of PEPS with the mesh wires being embedded. The relative proportions of active material, conductive additives, and polymer binder may range, for example, from 50 wt. % to 90 wt. % for the active material and 0 wt. % to 50 wt. % for the conductive additives, the balance being the polymer binder. The anode materials may not cover the pores fully as polymer or gel polymer electrolytes need to be filled subsequently. As previously stated, the depth of the pores or the thickness of the PDSA ranges from 25 microns to 200 microns; therefore, the thickness of the cathode may not exceed 400 microns, noting that two layers of PDSA films are used to form PEPS.

Another important embodiment of the invention is to use Li metal anode for its highest capacity. Li metal is very soft; a thin sheet of the metal may be readily pressed into the pores of PEPS, forming a Li metal PCE.

A polymer or gel polymer electrolyte may be subsequently deposited on top of the Li-ion cathode or anode electrode coatings in the pores of the PEPS. Any suitable polymer electrolytes may be used in the invention. The thickness of the polymer electrolyte coatings may range, for example, from 10 microns to 100 microns. One embodiment of the present invention utilizes an electrolyte separator film instead of a polymer electrolyte that will be wetted along with the electrode with a liquid electrolyte solution before the final packaging.

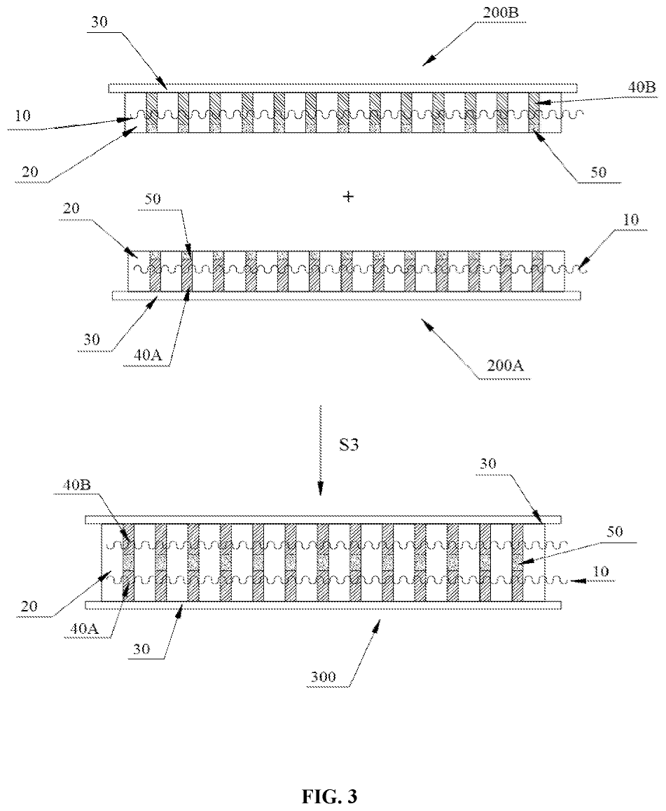

Referring to FIG. 3 of the drawing is a process of forming a flexible Li-ion battery (300) by aligning and pressing the positive and negative PCEs using the patterned pressure-sensitive DSAs as adhesives for self-bonding, wherein flexible Li-ion battery 300 is illustrated in a cross-sectional view. An appropriate, uniform pressure may be applied to the pair of PCEs to ensure a seamless bonding between the positive and negative PCEs. The structure of the formed flexible Li-ion battery may be viewed as a polymer-ceramic composite reinforced with metal mesh fibers with an array of micro/small Li-ion cells embedded in the continuous flexible polymer phase and connected in parallel using metal mesh current collectors.

Flexible Li-ion battery 300 will be further packaged by first peeling off release liners 30 and bonding 300 to a pair of metalized plastic or ultrathin glass sheets, using the pressure-sensitive adhesives. In addition, multiple layers of Li-ion batteries 300 may be bonded together using the pressure-sensitive adhesives, forming a battery of larger capacity before the final packaging. Furthermore, when a curable pressure-sensitive adhesive polymer is used in the device, the flexible Li-ion battery 300 may be pre-shaped, followed by the curing of the curable polymeric adhesive, forming a structural battery with a desired geometry. Lastly, a self-healing polymer adhesive may also be used in the PEPS to self-heal from mechanical and thermally induced damage to the batteries, therefore improving their safety.

Having generally described the invention, the following examples serve to illustrate the preferred embodiments of the present invention and should not be construed as limiting the scope of the invention:

Preparation of PEPS 100 with Square Pore Structures

Example 1: A mesh of stainless steel (SS, 11×3 cm², mesh opening 225 μm, wire diameter 25 μm), with a thin layer (˜1 μm) of copper on mesh wire, was cleaned by repeated soaking and sonicating in 50% isopropyl alcohol (IPA) for 16 hrs., and dried in an oven at 160° C. for 1 hr. A pair of PDSAs (100.5 cm×3.6 cm) were made using a laser cutting machine. The PDSA comprises a layer of silicone pressure-sensitive adhesive (100 μm thick) with two protective release liners on both sides. The pore structures of the PDSAs comprise an array of square (1 mm) pores, where there are 18 pores in the column and 64 in the row. The distance between the adjacent square centers is equally 1.5 mm, leaving the distance from the edge of the DSA to the edge of the nearest square to 5 mm. With one side of the release liners being removed, the pair of the PDSAs, sandwiching the metal mesh, were aligned, and bonded to themselves through the metal mesh, followed by removing another protective liner and attaching a piece of release liner 30 to the PDSA, forming PEPS 100 with the square pore structures for making flexible Li-ion anodes.

Example 2: A PEPS 100, with the square pore structures for making flexible Li-ion cathodes, was made following the procedure in Example 1, except that a mesh of stainless steel (SS), with a thin layer (˜1 μm) of aluminum instead of copper, is used.

Preparation of PEPS 100 with Rectangular Pore Structures

Example 3: A mesh of stainless steel (SS, 11×3 cm², mesh opening 225 μm, wire diameter 25 μm), with a thin layer (˜1 μm) of copper on mesh wire, was cleaned by repeated soaking and sonicating in 50% isopropyl alcohol (IPA) for 16 hrs., and dried in an oven at 160° C. for 1 hr. A pair of PDSAs (100.5 cm×3.6 cm) were made using a laser cutting machine. The PDSA comprises a layer of silicone pressure-sensitive adhesive (100 μm thick) with two protective release liners on both sides. The pore structures comprise an array (row) of rectangular pores, where there are 64 rectangular (2.8 cm×0.1 cm) pores in the row. The distance between the adjacent rectangular centers is equally 1.5 mm, leaving the distance from the edge of the PDSA to the edge of the nearest square 5.0 mm. With one side of the release liners being removed, the pair of the patterned DSAs, sandwiching the metal mesh, were aligned, and bonded to themselves through the metal mesh, followed by removing another protective liner and attaching a piece of release film 30 to the patterned adhesive, forming PEPS 100 with the rectangular pore structures for making flexible Li-ion anodes.

Example 4: A PEPS 100, with rectangular pore structures for making flexible Li-ion cathodes, was made following the procedure in Example 3, except that a mesh of stainless steel (SS), with a thin layer (˜1 μm) of aluminum instead of copper, is used.

### Preparation of PCE 200

Example 5: One of the PEPSs 100 prepared in the above examples was placed on a flat working bench with the pore openings faceup. A thin layer of a Li-ion electrode slurry was applied on the surface of the PEPS. A doctor blade was applied to the thin layer, forcing the slurry to fill the pores. The PEPS filled with electrode slurry was dried in an oven at an elevated temperature, e.g., 160° C., for 6 hrs. The thickness of the last remaining protective liner of the PDSA and the solid content of the electrode slurry dictated the thickness of the dried electrode. The pores were not fully filled with the dried electrode materials, allowing subsequent deposition of polymer or gel polymer electrolyte. After deposition of the polymer electrolyte solution and drying under a vacuum, a PCE was formed. Typically, the thickness of the electrode was ˜ 150 μm and the electrolyte˜50 μm. The total thickness of the electrode and electrolyte was 1-10% larger than 200 μm to ensure seamless bonding between the polymer electrolyte layers in the anode and cathode PCEs in the subsequent step.

### Preparation of Flexible Li-Ion Battery 300

Example 6: The last protective release liners were removed from the anode and cathode PCEs prepared in Example 5. The pair of PCEs were then aligned with precision and bonded under pressure at an elevated temperature. The pressure and temperature were needed to ensure the seamless bonding of the adhesive to the adhesive and the electrolyte to the electrolyte. Finally, the pair of the release liners (30) were removed from 300; and the flexible Li-ion battery 300 was further packaged using a metalized plastic pouch, e.g., aluminum-plastic film, which was bonded to the pressure-sensitive adhesives and heat-sealed at the edge of the pouch.

The embodiments of the present invention described above are exemplary. Many changes and modifications may be made to the disclosures recited above while remaining within the scope of the invention. The scope of the invention should, therefore, be determined not with reference to the above descriptions but instead should be determined with reference to the appended claims, along with their total equivalents.

What is claimed:

1. A method of making a Li-ion battery comprising: 1) forming a Patterned Electrode Preparation Substrate (PEPS), using a pair of well-aligned Patterned Double-Sided Adhesive (PDSA) films, having an array of pore structures, sandwiching and pressing against a metal mesh current collector, followed by adhering a side of the PDSA film to a release liner to close an end of said array of pore structures; 2) forming a Patterned Composite Electrode (PCE) by depositing an electrode and an electrolyte materials into said array of pore structures on said release liner; and 3) forming a Li-ion battery by aligning, and seamless bonding a positive and a negative PCEs using the PDSAs on said PEPS, followed by packaging.

2. The method according to claim 1, wherein the Patterned Double-Sided Adhesive (PDSA) comprises a pressure-sensitive adhesive selected from the group of silicone, acrylic, unsaturated polyester, polyurethane, and epoxy resin, wherein the PDSA film has a thickness ranging from 25 to 200 microns.

3. The method according to claim 1, wherein the Patterned Double-Sided Adhesive (PDSA) comprises a curable polymer adhesive and a self-healing polymer adhesive.

4. The method according to claim 1, wherein said array of pore structures on the PDSA film has a pore size ranging from 25 microns to 25 centimeters in diameter and 25 to 200 microns in depth, and pore density from 50% to 95%.

5. The method according to claim 1, wherein said metal mesh current collector comprises a material selected from the group of Al, Cu, Ni, Sb, Cr, stainless-steel, and Si.

6. The method according to claim 1, wherein said metal mesh current collector is a stainless-steel mesh having a thin layer of a metal selected from the group of Al and Cu on the stainless-steel wire.

7. The method according to claim 1, wherein said metal mesh current collector has a wire diameter ranging from 5 to 100 microns and a mesh pore opening from 5 to 300 microns.

8. The method according to claim 1, wherein the electrode is a Li-ion anode comprising a Li-ion anode active material, a conducting additive, and a polymer binder, wherein the anode active material comprises a material selected from the group of Li metal, graphite, Si, or LiTiO (lithium titanate oxide).

9. The method according to claim 1, wherein the electrode is a Li-ion cathode comprising a Li-ion cathode active material, a conducting additive, and a polymer binder, wherein the cathode active material comprises a material selected from the group of LiCoO₂, LiNiO₂, LiMn₂O₄, LiFePO₄, LiNiₓCo_{y}Mn_{z}, or LiNiₓCo_{y}Al_{z}.

10. The method according to claim 1, wherein the electrolyte comprises a polymer electrolyte, a gel polymer electrolyte, and a composite polymer electrolyte.

11. The method according to claim 1, wherein the thickness of the electrode ranges from 30 microns to 400 microns.

12. The method according to claim 1, wherein the thickness of the electrolyte ranges from 10 microns to 100 microns.
